(19) United States
(12) Patent Application Publication
(10) Pub. No.: US 2005/0263951 A1
(43) Pub. Date: Dec. 1, 2005

(54) Process and device for checking the space between coated sheets for welding

(76) Inventors: Klaus Goth, Sindelfingen (DE); Mike Paelmer, Weil der Stadt (DE); Daniel Zauner, Ballendorf (DE)

Correspondence Address: PENDORF & CUTLIFF, 5111 Memorial Highway, Tampa, FL, 33634-7356, US

(21) Appl. No.: 11/140,037

(22) Filed: May 27, 2005

(30) Foreign Application Priority Data
May 27, 2004 (DE) 10 2004 025 935.6

(51) Int. Cl. B41J 1/00

(52) U.S. Cl. 270/52.18

(57) ABSTRACT

In coated sheets the coating material often has a significantly lower melting point than the material of the sheet. Accordingly, when welding together this type of sheets, there may occur explosion-like evaporation of coating material, which significantly compromises the quality of the joint. For improving the joining quality it has already been proposed to provide a narrow gap between the sheets, through which the vaporized coating material can escape. The present invention provides a process and a device for simple and reliable checking the spacing of the sheets. This is done by a process and a device in which on at least one side of a first sheet topographical changes are produced projecting from the surface, the first sheet is positioned and clamped relative to a second sheet with the topographical changes projecting from the surface defining a minimal spacing between the two sheets through which spacing, during welding, vaporized products can escape, and wherein it is checked whether the two sheets are in contact with each other via the topographical changes projecting from the surface.

### BACKGROUND OF THE INVENTION

1. Field of the Invention

The invention concerns a process for welding coated sheets according to the pre-characterizing portion of Patent Claim 1 and a device for welding coated sheets according to the pre-characterizing portion of Patent Claim 6. A process of this general type is already known from DE 10241593 A1.

2. Related Art of the Invention

In the case of many coated sheets, in particular zinc coated sheet metal as employed in the automobile industry, the coating material exhibits a significantly lower melting point than the melting point of the sheet material. Accordingly, during laser welding of this type of sheet, explosive like evaporation of coating material can occur in the overlap joint, which strongly compromises the quality of the joint.

For improving the joint quality it has already been proposed to use spacers to produce a narrow gap between the sheets, so that the evaporated coating material can escape. Suitable crater-shaped spacers can be produced according to JP 11-047967 by laser radiation of the surface. Knob-shaped spacers are disclosed in DE 10241593 A1.

This type of spacer ensures in its environment a minimum spacing of the sheets. The spacing however may not be too large, since then it is no longer possible to produce a welding joint. In order to ensure this spacing, the sheets are clamped against each other. The achievement of even quality over the entire surface is possible only with high complexity and effort, and is sometimes not possible. In particular in the case of curved sheets and/or insufficient clamping force an optimal spacing cannot be reliably ensured.

### SUMMARY OF THE INVENTION

The task of the present invention is thus comprised of providing a process in a device for simple and reliable checking of the sheet spacing.

The invention is set forth in the characteristics of Patent Claims 1 and 6 with regard to the process and device to be achieved. The dependent claims recite advantageous embodiments and further developments of the inventive process (Patent Claims 2 through 5) and sheet (Patent Claims 7 and 8).

### DETAILED DESCRIPTION OF THE INVENTION

With regard to the process to be provided, the invention is inventively solved thereby,
that at least one side of at least a first sheet is provided with topographic changes projecting from the surface,
that the at least one first sheet is positioned and clamped with respect to a second sheet in such a manner, that at least one of the topographic changes projecting from the surface defines a minimal spacing between the at least two sheets, through which vapor products produced during welding can escape, and
that it is checked, whether the at least two sheets are in contact with each other via at least one of the topographic changes projecting from the surface of at least one sheet.

The advantage of this embodiment is comprised therein, that a contact check according to the invention is substantially simpler to carry out than a precise measurement of the contact width between sheets, or a precise measurement of two sheets and therefrom a calculation of their spacing. The required measurement task is reduced to a simple check task.

This enables a simplified manipulation of the sheets in the clamped condition. From this, there results an improved construction quality and a low reject rate.

The topographic changes can be produced herein in any manner, so long as at least a sufficient reproducibility, in particular height precision, is ensured. For example, it can occur by laser beam radiation as disclosed in DE 10241593 A1 or also mechanically, in particular by stamping.

A sufficient reproducibility of the height precision of the topographic changes makes possible a reliable setting of a suitable spacing of the coated sheets. If contact between the sheets is proved via the topographic changes, than it is simultaneously the proof of the suitable spacing of the sheets, that is, a sufficient minimal spacing for passage of the evaporated coating and a permissible maximal spacing for ensuring a good welding joint.

In an advantageous embodiment of the inventive process the checking occurs essentially in the area of a topographic change. Therein the required testing device may be small and mobile and designed to be able to reach otherwise possibly difficult to access checking areas. With “area” the immediate vicinity of the topographic change is meant, preferably in the vicinity of less than 10 cm distance from the topographic changes.

In a further advantageous embodiment of the inventive process the checking occurrs over the total surface provided with topographic changes, either in points or integrally. The point check can occur with the present mentioned checking device, the integral with a corresponding surface sensor.

In such a checking over the total surface provided with topographic changes, the number of the contact points in relation to the number of the topographic changes can be used as a relative quality measurement of the sheet spacing. Likewise, the location of the contact points can be used as absolute quality measurement.

Detected defect locations with missing contact can be used for modification of the clamping tool and/or topographic changes. It is conceivable also to have in particular an immediate change of the clamping condition on the prior defect location by means of a mobile clamping device.

In an advantageous embodiment of the inventive process the checking occurs by measurement by ultrasound, capacitance, electrical resistance or eddy current. For this, both a signal transmitted through the sheet and a signal reflected therefrom could be employed.

This type of measurement provides significant signal distinctions between the presence or absence of contact, and thus ensures a high checking quality.

In a further advantageous embodiment of the inventive process the checking occurs essentially from one side of the sheets positioned against each other. This is possible both with the transmitted as well as with the reflective signals. In particular in the case of difficult to access components this one-sided checking is advantageous.

In components which exhibit on both sides areas with difficult access, or which require a higher checking precision, it is also possible that a two sided checking can be advantageously employed, which covers in certain cases on both sides only the accessible partial areas.

With regard to the device for welding of coated sheets, the task is inventively solved thereby, that it includes a welding device, a positioning device, a clamping device and a device for checking the local contact of the sheet.

The advantage of this embodiment is comprised—as already described in greater detail above—therein, that a complex measurement task is replaced by a simple checking task.

In one advantageous embodiment of the inventive device the device for checking the local contact is provided in the form of a device for measurement of ultrasound, capacitance, electrical resistance, or eddy currents.

This type of checking device provides clear signal distinctions in the case of the presence or absence of contact and thus ensures a high checking quality.

In a further advantageous embodiment of the inventive device, this includes a device for guiding the device for checking the local contact of the sheet, preferably a robot.

This is in particular advantageous when the checking device checks, in each checking step, respectively only one part of the sheet, and for the next checking step must again be moved. In particular in the case of complex shaped sheets with, in certain cases, limited accessibility, robots are particularly suited, which traverse the sheet in predetermined tracks or autonomously calculate suitable tracks.

In a further advantageous embodiment of the inventive device the welding device includes a scanner device for deflection of a welding laser beam on the surface of the sheet. The scanner device is in particular a rapid and flexible beam deflection device, for example a mirror system (including at least a one- or multi-axis controllable pivotable mirror), or could be an acoustic-optical modulator.

The laser beam particularly preferably produces the at least one topographic change on the side of the at least one sheet that is opposite to the laser, in that it melts all the way through this sheet in the area of its work or effective surface. This can (however need not) take place in the already positioned condition of the two sheets. For this, a suitable processing time is to be allowed for passage through of the laser beam, or a passage-through sensor is to be provided, which controls the processing time. This embodiment enables a further acceleration of the process for the welding together of multiple sheets. In the process according to JP 11-047967 first a single sheet is oriented and then topographical changes are provided on the sheet, thereafter a second sheet is provided and positioned relative to the first, and then both are clamped and welded. It is however advantageous to simultaneously orient both sheets together without application of pressure. In the absence of application of pressure there remains, for most applications, a sufficient minimal gap between the sheets; it can however also be provided by a suitable orientation or positioning device. Thereafter topographical changes are introduced through one or possibly through both of the sheets according to this advantageous embodiment of the inventive process. Thereafter the sheets are clamped and welded to each other. In consideration of the high speed of available scanner devices and the production of the topographical changes, this means a saving of one positioning process, and from the directly following integrated checking of the sheet condition, there results a very substantial savings in time.

In the following the inventive process and the inventive device will be described in greater detail on the basis of an illustrative embodiment:

The exemplary embodiment of the device includes a welding device, a positioning device, a clamping device and a device for checking the local contact of the sheet.

The welding device is a laser scanner device. The device for checking the local contact of the sheets is an ultrasound impulse provider and ultrasound sensor, which are mounted on a robot, which can guide them to a suitable checking position.

First, two coated steel sheets are positioned relative to each other by means of the positioning device. Thereby they exhibit a spacing from each other, which spacing is so large, that it does not permit a welding joining of the two sheets.

Next, two electrolytically zinced steel sheets with a thickness of 1.2 mm are oriented, spaced apart from each, other by means of the positioning device. Therein they exhibit a spacing from each other which is so large, that no welding joining of the two sheets is possible.

Then, by means of the laser scanning device, topographical changes are introduced at predetermined positions on the sheet facing the laser, on the side of the sheet opposite to the laser, by passing through the sheet. The laser beam has a power or output of 3.5 kW and a processing speed of 7 m/min. The laser beam is guided by the scanner device in such a manner, that it describes about and through the center of its active or processing surface a decreasing spiral with a starting diameter of 1.2 mm, wherein it reaches the center after five orbits. For this it requires a processing time of 100 ms. By the spiral shaped movement from outside towards inside, there occurs an even formation of the topographic change upon the laser-opposite side of the sheet in the form of an even-contoured mountain or peak. After production of the necessary number of topographic changes both sheets are clamped. Therein the minimal distance between the two sheets is defined by the topographical changes projecting from the surface, through which the vapor products produced during welding can escape.

Next, the checking device is guided via the robot over the side of the sheet facing the laser beam. Therein an impulse is transmitted by the ultrasound impulse provider, reflected by the sheets, and received by the ultrasound receiver, and thereafter on the basis of the received signals areas with and without contact of the sheets are determined and compared with intended contact areas. If the intended/actual comparison is positive, then the sheets are welded to each other in the area of the topographic changes.

If the intended/actual comparison is negative, then the sheets are follow-up clamped, the contact is again checked, and, in the case of positive intended/actual comparison, are welded to each other.

The inventive process and the inventive device in the embodiment of the above described example have proven themselves as particularly suited for the checking of the spacing of coated sheets, in particular during laser welding in the automobile industry. Thereby substantial advantages with regard to work quality can be achieved.

The invention is not limited to only the above described embodiment, but rather is broadly applicable.

Thus it is conceivable for example, in place of guiding the checking device over the sheets using a robot, to leave this stationary over the sheets and to guide the testing signal over the sheet by means of a scanner device analogously to the laser beam. Therein, the spacing of the scanner device from the sheet, the degree of the focusing of the test signal or the movement pattern thereof can be adapted to the material of the sheet and/or coating. Supplementally, it can be advantageous to vary the signal power during the checking in suitable manner.

The device for checking the local contact of the sheet can also be integrated into a moving clamping device, in order to carry out the checking directly prior to the welding.

1-8. (canceled)

9. A process for welding coated sheets, comprising:
producing on at least one side of at least a first sheet at least one topographical change projecting from the surface,
positioning the at least one first sheet and clamping it relative to at least one second sheet, such that at least one topographical change projecting from the surface defines a minimal spacing between the first and second sheets, the spacing being sufficient to allow vaporization products occurring during welding to escape,
checking in the area of the topographical change whether the at least two sheets are in contact with each other via the at least one topographical change projecting from the surface of at least one sheet.

10. The process according to claim 9, wherein the checking occurs within 10 cm from the topographical change.

11. The process according to claim 9, further comprising changing the clamping condition of the sheets when a defect area lacking contact is detected.

12. The process according to claim 9, wherein the checking involves measurement of ultrasound, capacitance, electrical resistance or eddy currents.

13. The process according to claim 9, wherein the checking occurs from one side of the sheets positioned against each other.

14. A device for welding coated sheets, the device including:
a welding device,
a positioning device,
a clamping device,
a device for checking the local contact of the sheets, and
a device for guiding the device for checking the local contact over the sheets.

15. The device according to claim 14, wherein the device for checking the local contact is at least one of a device for measuring ultrasound, capacitance, electrical resistance and eddy currents.

16. The device according to claim 14, wherein the device for guiding the device for checking the local contact over the sheet is a robot.
